(19) United States
(12) Patent Application Publication
(10) Pub. No.: US 2010/0225568 A1
(43) Pub. Date: Sep. 9, 2010

(54) ELECTRO-OPTICAL-APPARATUS SUBSTRATE, ELECTRO-OPTICAL APPARATUS AND ELECTRONIC APPLIANCE

(75) Inventor: Yasushi Yamazaki, Azumino-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/699,188

(22) Filed: Feb. 3, 2010

(30) Foreign Application Priority Data
Mar. 5, 2009 (JP) 2009-052229
Sep. 15, 2009 (JP) 2009-213327

(51) Int. Cl. G09G 3/20

(52) U.S. Cl. 345/55

(57) ABSTRACT

An electro-optical-apparatus substrate includes, a substrate, a plurality of scanning lines and a plurality of data lines provided on the substrate, the scanning lines and data lines intersecting each other; a plurality of pixel electrodes provided at intersections of the plurality of scanning lines and the plurality of data lines; and a plurality of semiconductor devices that control on/off switching of the pixel electrodes, each of the plurality of semiconductor devices corresponding to the pixel electrode. At least one semiconductor device among the plurality of semiconductor devices is arranged so as to be at least partially covered by another pixel electrode that is adjacent to one pixel electrode that corresponds to the one semiconductor device when viewed on the substrate in plan view.

### BACKGROUND

1. Technical Field

The present invention relates to an electro-optical-apparatus substrate, an electro-optical apparatus that includes the electro-optical-apparatus substrate and an electronic appliance that includes the electro-optical apparatus.

2. Related Art

An electro-optical apparatus including this type of substrate is configured to be capable of active-matrix driving by being provided on the substrate thereof with pixel electrodes, scanning lines for selectively driving the pixel electrodes, data lines and pixel-switching thin-film transistors (TFTs). In active-matrix driving, scanning signals are supplied to the scanning lines in order to control the operation of the pixel-switching TFTs and pixel signals are supplied to the data lines at a timing at which the TFTs are driven so as to be switched on, whereby the display of an image is realized.

For example, an electro-optical apparatus in which pixel electrodes are arranged on a substrate so as to cover bottom-gate TFTs electrically connected to the pixel electrodes when viewed on the substrate in plan view is disclosed in JP-A-2008-46595.

However, according to the above-described example of the related art, there is a technical problem in that the parasitic capacitance between a pixel electrode and a gate region that is electrically connected to a scanning line in a TFT is large and there is a possibility that the pixel electrode will be greatly affected by fluctuations in the electric potential supplied to the scanning line.

### SUMMARY

An advantage of some aspects of the present invention is that it provides an electro-optical-apparatus substrate, an electro-optical apparatus and an electronic appliance capable of suppressing the influence of fluctuations in the electric potential of a scanning line on a pixel electrode.

An electro-optical-apparatus substrate according to a first aspect of the invention, includes, on a substrate, a plurality of scanning lines and a plurality of data lines, the scanning lines and data lines intersecting each other, a plurality of pixel electrodes provided at intersections of the plurality of scanning lines and the plurality of data lines, and a plurality of semiconductor devices that control on/off switching of the pixel electrodes and respectively correspond to the plurality of pixel electrodes. At least one semiconductor device among the plurality of semiconductor devices is arranged so as to be at least partially covered by another pixel electrode that is adjacent to one pixel electrode that corresponds to the one semiconductor device when viewed on the substrate in plan view.

With the electro-optical-apparatus substrate according to the first aspect of the invention, for example, supply of image signals from the data lines to the pixel electrodes is controlled and image display can be realized using the so-called active-matrix driving method. Moreover, an image signal is supplied to a pixel electrode from a data line via a semiconductor device at a predetermined timing by turning the semiconductor device on and off, the semiconductor device controlling on/off switching of the pixel electrode and being electrically connected between the corresponding data line and pixel electrode.

The pixel electrodes are, for example, composed of a conductive material such as aluminum or indium tin oxide (ITO) and a plurality of the pixel electrodes are provided in a matrix pattern on the substrate so as to correspond to intersections of the plurality of data lines and the plurality of scanning lines in a region that is to become a display region.

At least one semiconductor device among the plurality of semiconductor devices is arranged so as to be at least partially covered by another pixel electrode that is adjacent to one pixel electrode that corresponds to the one semiconductor device when viewed on the substrate in plan view. In other words, one pixel electrode is arranged so as to at least partially cover a semiconductor device corresponding to another pixel electrode adjacent to the one pixel electrode when viewed on the substrate in plan view.

In addition, it is preferable that the one semiconductor device be arranged so as to not be covered by the one pixel electrode corresponding thereto in plan view.

According to research carried out by the inventors of the present application, when a semiconductor device is arranged so as to be covered by the pixel electrode corresponding thereto when viewed on the substrate in plan view, the parasitic capacitance generated between the pixel electrode and the gate region, which is electrically connected to the scanning line for the one semiconductor device, becomes large and there is a risk that the pixel electrode will be greatly affected by fluctuations in the electric potential supplied to the scanning line.

Furthermore, in the case where one pixel electrode is arranged so as to be covered by the scanning line when viewed on the substrate in plan view, the one pixel electrode and the pixel electrode adjacent thereto must be arranged with a gap therebetween in order to prevent short circuits. In this case, if the one semiconductor device, which corresponds to the one pixel electrode, is arranged so as to be covered by the one pixel electrode when viewed on the substrate in plan view, there is a risk that the efficiency with which the pixel electrodes are arranged will be reduced in proportion to the size of the gap that must be provided between the one pixel electrode and the other pixel electrode. Furthermore, in the case in which this type of substrate is used in a transmissive liquid crystal apparatus, as an example of an electro-optical apparatus, it turns out that there is a risk that the aperture ratio of the apparatus will be reduced.

In contrast, according to the first aspect of the invention, one semiconductor device is arranged so as to be at least partially covered by another pixel electrode that is adjacent to one pixel electrode that corresponds to the one semiconductor device. Consequently, the parasitic capacitance between the gate region of the one semiconductor device and the one pixel electrode corresponding to the one semiconductor device can be reduced. As a result, the effect of fluctuations in the electric potential of the scanning line on the one pixel electrode can be suppressed.

In addition, since the one semiconductor device is arranged so as to be at least partially covered by the other pixel electrode when viewed on the substrate in plan view, the other pixel electrode functions as a shielding layer and the effect of noise on the one semiconductor device can be suppressed. Furthermore, when the other pixel electrode is formed using a material having a light-shielding property such as aluminum, the other pixel electrode functions as a light-shielding layer, whereby generation of a photo leakage current can be suppressed in the one semiconductor device.

In the electro-optical-apparatus substrate according to the first aspect of the invention, the other pixel electrode is preferably a pixel electrode that is adjacent to the one pixel electrode in the direction in which the data line of the one pixel electrode extends.

According to the first aspect of the invention, different scanning lines are electrically connected to the one pixel electrode and the other pixel electrode. Scanning signals are supplied to the scanning line electrically connected to the one pixel electrode and the scanning line electrically connected to the other pixel electrode at different times. Consequently, the effect of fluctuations in the electric potential of the scanning line on the one pixel electrode can be further suppressed.

In the electro-optical-apparatus substrate according to the first aspect of the invention, each of the plurality of pixel electrodes preferably includes a material that exhibits conductivity and has a light-shielding property.

According to the first aspect of the invention, since the other pixel electrode that at least partially covers the one semiconductor device functions as a light-shielding layer, generation of a photo leakage current in the one semiconductor device can be suppressed and this is very advantageous in actual use.

In addition, the degree of light-shielding provided by the “material exhibiting a light-shielding property” in the first aspect of the invention, is preferable extremely high (for example, the material has an optical transmissivity of zero), but it is sufficient that the degree of light-shielding be such that generation of a photo leakage current in the one semiconductor device can be more or less completely suppressed.

In the electro-optical-apparatus substrate according to the first aspect of the invention, it is preferable that each of the plurality of semiconductor devices include a channel region having a channel length that is parallel to the direction in which the data line extends.

According to the first aspect of the invention, since the area occupied by a single pixel on the substrate can be reduced, for example, pixel density can be improved and an electro-optical apparatus incorporating the electro-optical-apparatus substrate can be designed so to have a reduced size.

In the electro-optical-apparatus substrate according to the first aspect of the invention, it is preferable that each of the plurality of pixel electrodes have a transparent portion through which light passes and a light-shielding portion that blocks light, and it is preferable that the light-shielding portion be arranged so as to at least partially cover the one semiconductor device.

According to the first aspect of the invention, the one semiconductor device is at least partially covered by the light-shielding portion included in the other pixel electrode that is adjacent to the one pixel electrode corresponding to the one semiconductor device. Accordingly, generation of the photo leakage current in the one semiconductor device can be suppressed with certainty by the light-shielding portion.

Furthermore, according to the first aspect of the invention, each of the plurality of pixel electrodes has a transparent portion. The transparent portion is formed in a region other than the region in which the light-shielding portion is formed in the region in which the pixel electrode is formed. Therefore, reflection of light incident from the outside (that is, outside light) on the pixel electrode can be suppressed. In other words, for example, reflection of light by the pixel electrode formed of material that has a light-shielding property such as aluminum can be suppressed. Accordingly, contrast can be improved.

An electro-optical apparatus according to a second aspect of the invention includes the electro-optical-apparatus substrate according to the above-described first aspect of the invention.

With the electro-optical apparatus according to the second aspect of the invention, since the electro-optical apparatus is provided with the above-described electro-optical-apparatus substrate according to the first aspect of the invention, the effect of fluctuations in the electric potential of the scanning line on the at least one pixel electrode among the plurality of pixel electrodes can be suppressed.

An electronic appliance according to a third aspect of the invention includes the above-described electro-optical apparatus according to the second aspect of the invention.

The electronic appliance according to the third aspect of the invention includes the above-described electro-optical apparatus according to the second aspect of the invention, whereby a variety of electronic appliances that can perform high-quality display, such as a projection display apparatus, a mobile telephone, an electronic organizer, a word processor, viewfinder-type and monitor-direct-view-type videotape recorders, a workstation, a video telephone, a POS terminal and a touch panel, can be realized.

Furthermore, as examples of the electronic appliance according to the third aspect of the invention, an electrophoretic display such as an electronic paper sheet, a field-emission display or a conduction-electron-emitter display, and a display that uses a field-emission display or a conduction-electron-emitter display can be realized.

The operations and other advantages of aspects of the invention will be made clear from the following description of embodiments.

### BRIEF DESCRIPTION OF THE DRAWINGS

The invention will be described with reference to the accompanying drawings, wherein like numbers reference like elements.

FIG. 1 is a block diagram illustrating the entire configuration of an electrophoretic display according to an embodiment of the invention.

FIG. 2 is a plan view illustrating a plurality of adjacent pixel units according to the embodiment of the invention.

FIG. 3 is a sectional view taken along line III-III of FIG. 2.

FIG. 4 is a plan view illustrating adjacent pixel units according to a first modification of the embodiment of the invention.

FIG. 5 is a sectional view illustrating a plurality of adjacent pixel units according to a second modification of the embodiment of the invention.

FIG. 6 is a plan view illustrating adjacent pixel units according to a third modification of the embodiment of the invention.

FIG. 7 is a sectional view illustrating a plurality of adjacent pixel units according to the third modification of the embodiment of the invention.

FIG. 8 is a perspective view illustrating the configuration of an electronic paper sheet as an example of an electronic appliance to which the electrophoretic display has been applied.

FIG. 9 is a perspective view illustrating the configuration of an electronic notebook as another example of an electronic appliance to which the electrophoretic display has been applied.

### DESCRIPTION OF EXEMPLARY EMBODIMENTS

Hereafter, an electro-optical-apparatus substrate, an electro-optical apparatus provided with the electro-optical-apparatus substrate, and an electronic appliance provided with the electro-optical apparatus according to embodiments of the invention will be described with reference to the drawings.

### Electro-Optical Apparatus

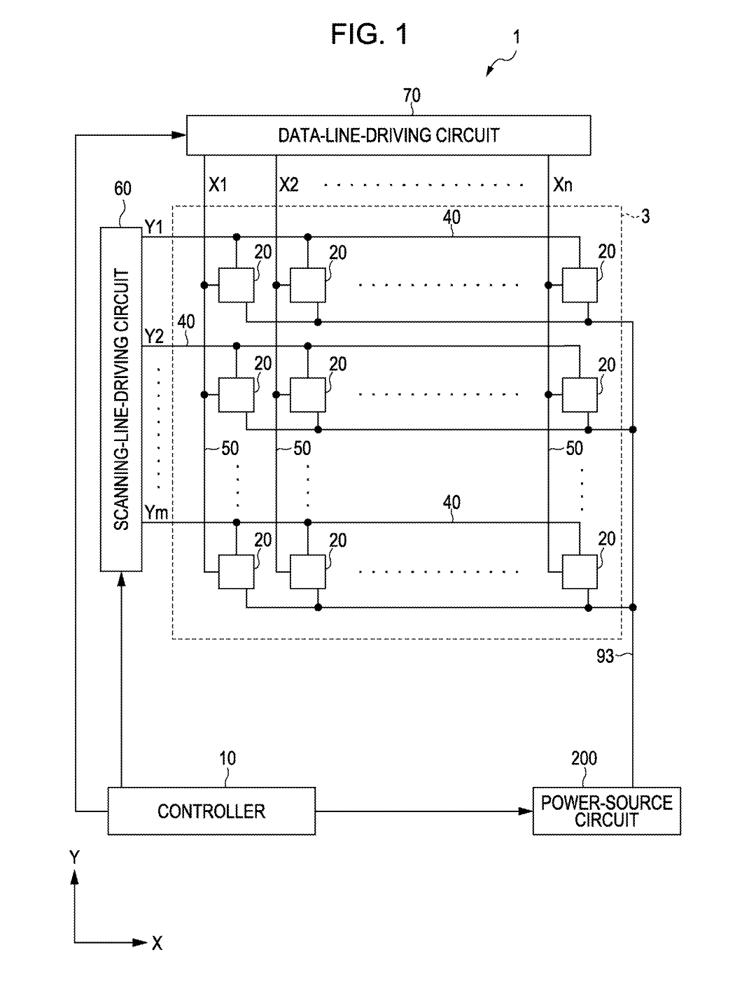

An embodiment of an electro-optical apparatus according to the invention will be described with reference to FIGS. 1 to 3. In this embodiment, an electrophoretic display will be described as an example of the electro-optical apparatus according to the second aspect of the invention. Furthermore, in the figures referred to hereafter, in order to make individual layers and components be of a recognizable size, the individual layers and components have been drawn to different scales.

First, the entire configuration of the electrophoretic display according to the embodiment will be described with reference to FIG. 1. FIG. 1 is a block diagram illustrating the entire configuration of the electrophoretic display according to the embodiment of the invention.

As illustrated in FIG. 1, an electrophoretic display 1 is provided with a display unit 3, a scanning-line-driving circuit 60, a data-line-driving circuit 70, a controller 10 and a power-source circuit 200.

In the display unit 3, m rows by n columns of pixels 20 are arrayed in a matrix pattern (two-dimensional planar pattern). In addition, m scanning lines 40 (that is, scanning lines Y1, Y2, . . . , Ym) and n data lines 50 (that is, data lines X1, X2, . . . , Xn) are provided so as to intersect each other. Specifically, the m scanning lines 40 extend in a row direction (X direction) and the n data lines 50 extend in a column direction (Y direction). The pixels 20 are arranged at positions corresponding to intersections of the m scanning lines 40 and the n data lines 50.

The controller 10 controls operations of the scanning-line-driving circuit 60, the data-line-driving circuit 70 and the power-source circuit 200.

The scanning-line-driving circuit 60 sequentially supplies a scanning signal in a pulse-like manner to the individual scanning lines Y1, Y2, . . . , Ym in accordance with a timing signal. The data-line-driving circuit 70 supplies an image signal to the data lines X1, X2, . . . , Xn in accordance with a timing signal. The image signal takes two numerical levels, for example, a high potential level (hereafter, “high level” e.g. 5 V) and a low potential level (hereafter, “low level” e.g. 0 V). Furthermore, gradation display can be performed by adjusting the pulse width and amplitude of the image signal, and the number of frames that the image signal supplies.

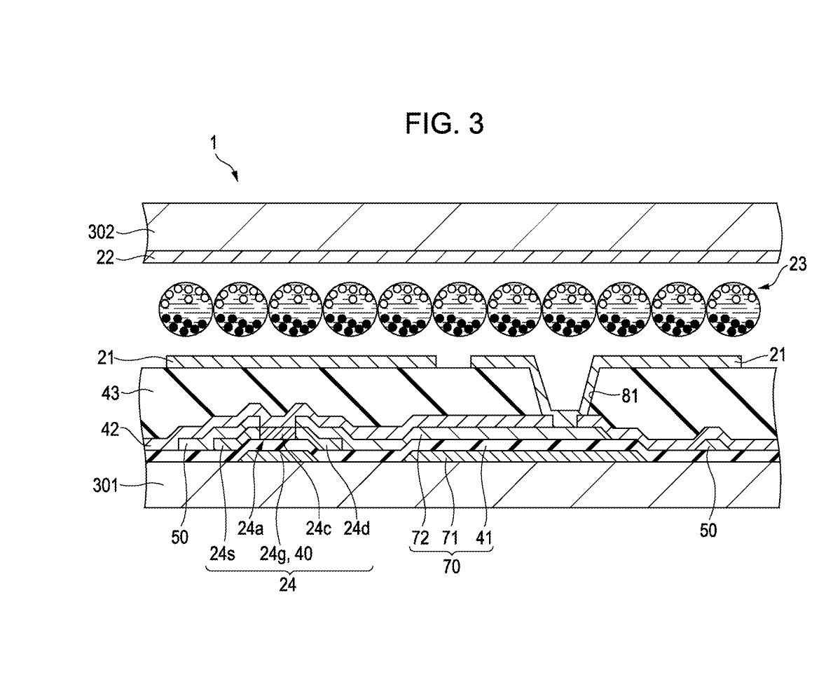

The power-source circuit 200 supplies a common potential to a common-potential line 93. Although not illustrated in the drawings, the common-potential line 93 is electrically connected to the power-source circuit 200 through an electrical switch. Furthermore, as illustrated in FIG. 1, for ease of explanation, each of the pixels 20 is configured so as to be electrically connected to the common-potential line 93 and the common potential is supplied through a common electrode 22 (refer to FIG. 3) that opposes the plurality of pixels 20. It goes without saying that, as illustrated in FIG. 1, the common potential line 93 may be connected to each of the pixels 20 and a common potential may be supplied to each of the pixels 20.

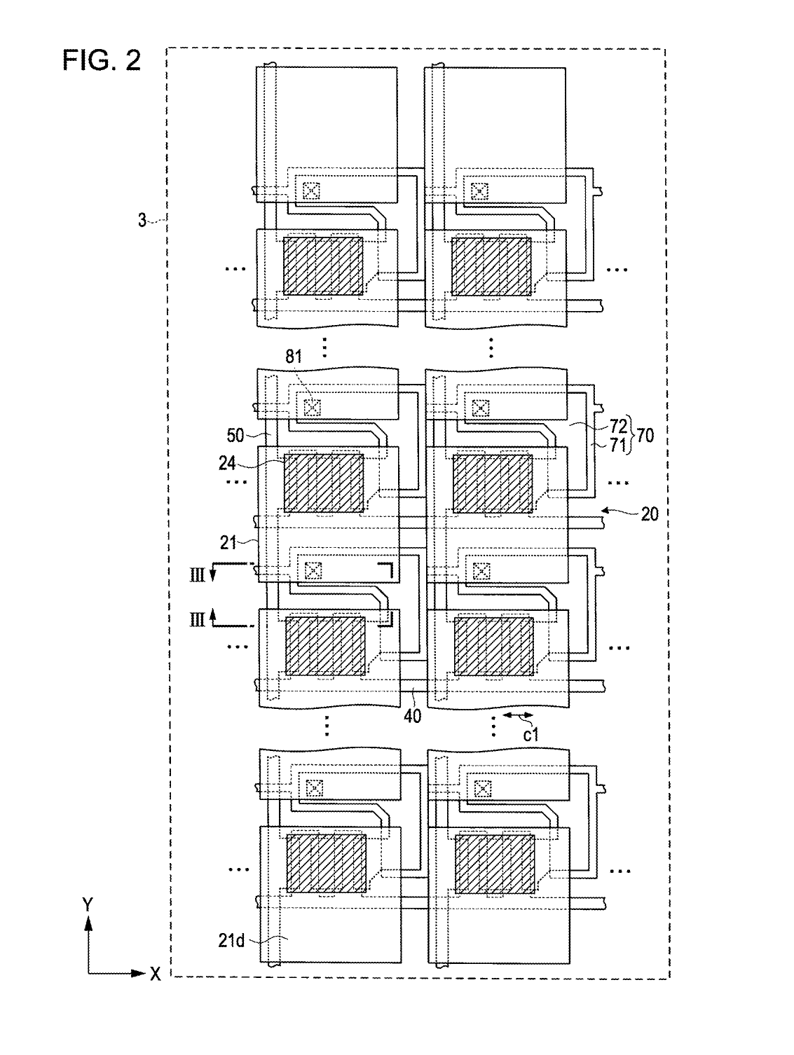

Next, the specific configuration of a pixel unit of the electrophoretic display 1 will be described with reference to FIGS. 2 and 3. Here, FIG. 2 is a plan view of a plurality of adjacent pixel units according to the embodiment of the invention and FIG. 3 is a sectional view taken along line III-III in FIG. 2. Moreover, for ease of explanation, only components that are directly related to the embodiment of the invention are illustrated in FIGS. 2 and 3.

In FIG. 3, an electrophoretic element 23 composed of a plurality of microcapsules each including electrophoretic particles is disposed between pixel electrodes 21 formed on a substrate 301 and the common electrode 22 formed on a substrate 302. Here, the electrophoretic element 23 may be arranged such that an adhesive is interposed between the electrophoretic element 23 and the pixel electrodes 21 and/or between the electrophoretic element 23 and the common electrode 22 or the electrophoretic element 23 may be arranged so as to directly contact either of or both of the pixel electrodes 21 and the common electrode 22.

In FIG. 2, the scanning lines 40 extend in the X direction and the data lines 50 extend in the Y direction, which intersects the direction in which the scanning lines 40 extend. The pixel electrodes 21 are arranged at positions corresponding to intersections of the scanning lines 40 and the data lines 50 and are composed of aluminum. As illustrated in FIG. 2, the pixel electrodes 21 are provided in a plurality and in a matrix pattern on the substrate 301 (refer to FIG. 3). Moreover, in this embodiment “aluminum” is but one example of the “material that exhibits conductivity and has a light-shielding property” in the first aspect of the invention.

In FIGS. 2 and 3, pixel-switching transistors 24, as an example of the “semiconductor devices” of the first aspect of the invention, are each configured to include a semiconductor layer 24a and a gate electrode 24g. A region occupied by each of the pixel-switching transistors 24 when viewed on the substrate 301 in plan view can be defined as, for example, the region in which the semiconductor layer 24a is arranged. By supplying the pixel-switching transistor 24 with a scanning signal from the scanning line 40, the switch provided by the pixel-switching transistor 40 is closed for just a predetermined period (in an on state, there is conduction between the source and drain). Accordingly, an image signal, which has been supplied from the data line 50, is written into the pixel 20 at a predetermined timing (that is, the voltage corresponding to the image signal is applied between the pixel electrode 21 and the common electrode 22).

The semiconductor layer 24a is composed of a channel region 24c, a source region 24s and a drain region 24d. The source region 24s is electrically connected to the data line 50 and the drain region 24d is electrically connected to an upper electrode 72 of a storage capacitor 70, which will be described below. As illustrated in FIGS. 2 and 3, the gate region 24g is formed as part of the scanning line 40. Furthermore, as illustrated by the double-headed arrow c1 in FIG. 2, the channel length of the channel region 24c of the pixel-switching transistor 24 is parallel to the direction in which the scanning line 40 extends.

As illustrated in FIG. 3, an insulating film 41 composed of, for example, silicon nitride (SiN) is provided between the semiconductor layer 24a and the gate electrode 24g. Furthermore, a protective film 42 composed of, for example, silicon nitride is provided on top of the semiconductor layer 24a, the data line 50 and the upper electrode 72.

In order to prevent leakage of a voltage corresponding to an image signal held between the pixel electrode 21 and the common electrode 22, the storage capacitor 70 is added so as to be electrically in parallel with the capacitance formed between the pixel electrode 21 and the common electrode 22. The storage capacitor 70 is composed of the upper electrode 72, a lower electrode 71 and the insulating film 41.

The pixel electrode 21 is electrically connected to the upper electrode 72 via a contact hole 81 formed through the protective film 42 and an interlayer insulating film 43. In addition, in FIG. 3, the portion extending from the substrate 301 to the pixel electrode 20 forms an example of the “electro-optical-apparatus substrate” according to the first aspect of the invention.

In this embodiment, as illustrated in FIG. 2, one pixel-switching transistor 24 is arranged so as to be covered by another pixel electrode 21 that is adjacent thereto in the direction in which the data line 50 of one pixel electrode 22 corresponding to the one pixel-switching transistor 24 extends when viewed on the substrate in plan view. In other words, one pixel electrode 21 is arranged so as to cover the pixel-switching transistor 24 corresponding to another pixel electrode 21 that is adjacent thereto in the direction in which the data line 50 of the one pixel electrode 21 extends when viewed in plan view.

Consequently, the parasitic capacitance between the gate region of the one pixel-switching transistor 24 and the one pixel electrode 21 corresponding to the one pixel-switching transistor 24 can be reduced. As a result, the effect of fluctuations in the electric potential of the scanning line 40 on the one pixel electrode 21 can be suppressed.

In addition, since one pixel-switching transistor 24 is arranged so as to be covered by another pixel electrode 21 when viewed on the substrate 301 in plan view, the other pixel electrode 21 functions as a shielding layer and the effect of noise on the one pixel-switching transistor 24 can be suppressed.

Furthermore, since each of the pixel electrodes 21 is composed of aluminum, the other pixel electrode 21 functions as a light-shielding layer and the generation of a photo leakage current in the one pixel-switching transistor 24 can be suppressed. In addition, there is no need for a light-shielding member on the substrate 302 side of the electrophoretic display 1, the substrate 302 being arranged opposite the substrate 301. Accordingly, for example, the distance between the substrates of an electrophoretic display or the like is particularly advantageous in a comparatively large apparatus. Here, even though a light-shielding member such as a black matrix (BM) is not provided, leakage of external light can be suppressed, since the pixel-switching transistors 24 can be shielded by the pixel electrodes 21. As a result, fluctuations in the potential of the pixel electrode 21 due to leakage of light can be almost completely eliminated or completely eliminated in practice and display can be performed with high quality. In electrophoresis displays, a reduction in contrast due to light from a backlight leaking out from between pixel electrodes does not occur. Furthermore, in electrophoresis displays, since electrophoresis particles are driven by a lateral electric field, even the areas between pixel electrodes effectively contribute to display. Accordingly, on the substrate 302 side of the electrophoretic display 1 (refer to FIG. 3), it is desirable that there be no light-shielding member such as a black matrix, so that the brightness of white can be high. Therefore, since a light-shielding member such as a black matrix is not provided and generation of a photo leakage current can be suppressed in the pixel-switching transistors 24, the electrophoretic display 1 according to this embodiment is also advantageous from the viewpoint that contrast is increased.

Furthermore, it is preferable that one pixel electrode 21 be arranged so as to cover a pixel-switching transistor 24 corresponding to another pixel electrode 21 that is driven before the one pixel electrode 21 and is adjacent to the one pixel electrode 21. In other words, it is desirable that one pixel electrode 21 be arranged so as to cover the pixel-switching transistor 24 that is electrically connected to the scanning line 40 of the preceding row. Here, the scanning line 40 of the preceding row is selected (that is, supplied with a scanning signal) before the scanning line 40 that corresponds to the one pixel electrode 21 and is referred to as a scanning line 40 that is adjacent to the scanning line 40 that corresponds to the one pixel electrode 21. By adopting such a configuration, the scanning line of the preceding row is shielded by (i.e., covered by) the pixel electrode 21 and since the electric potential thereof is constant at the off level, fluctuations in the electric potential of the pixel electrode 21 due to the scanning line 40 that is shielded by the pixel electrode 21 advantageously do not arise.

Furthermore, it is preferable that, for example, dummy electrodes 21d be provided around an edge portion of the display unit 3 so as to cover the pixel-switching transistors 24 arranged in the edge portion when viewed on the substrate 301 in plan view.

### First Modification

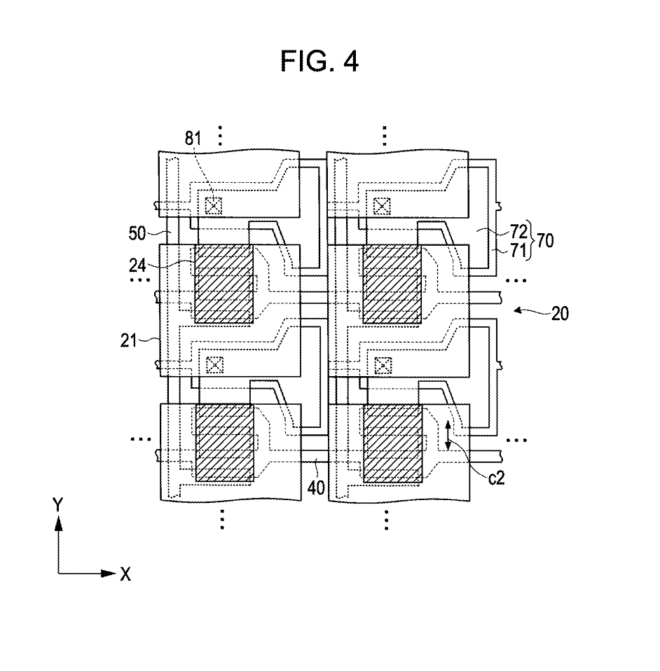

Next, a first modification of the electrophoretic display 1 according to the embodiment will be described with reference to FIG. 4. Here, similarly to FIG. 2, FIG. 4 is a plan view of adjacent pixels in the first modification of the embodiment.

In the first modification, the channel length of the channel region 24c of the pixel-switching transistor 24 is parallel to the direction in which the data line 50 extends, as illustrated by the double-headed arrow c2 in FIG. 4. By adopting such a configuration, the area occupied by a single pixel on the substrate 301 can be reduced and thereby for example the pixel density can be improved and the electrophoretic display 1 can be designed so as to be of reduced size.

### Second Modification

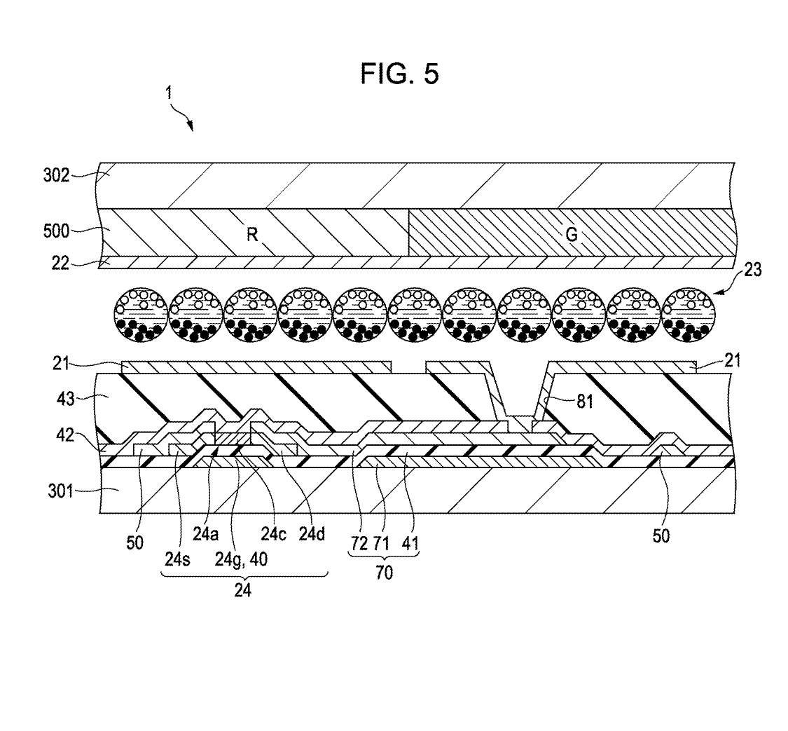

Next, a second modification of the electrophoretic display 1 according to the embodiment will be described with reference to FIG. 5. Similarly to FIG. 3, FIG. 5 is a sectional view of a plurality of adjacent pixel units in the second modification of the embodiment.

As illustrated in FIG. 5, in the second modification, a color-filter substrate 500 having coloring layers of three colors of red (R), green (G) and blue (B) is provided on the substrate 302 side of the electrophoretic display 1. Here, the coloring layers of the three colors of red, green and blue are arranged adjacent to one another in the color-filter substrate 500 without any light-shielding member such as a black matrix being provided. Even when a configuration is adopted in which a light-shielding member such as a black matrix is not provided on the substrate 302 side of electrophoretic display 1, as in this embodiment, generation of a photo leakage current due to external light can be prevented since the pixel-switching transistor 24 is shielded by the pixel electrode 21. As a result, fluctuations in the electric potential of the pixel electrode 21 due to a photo leakage current can be almost completely or completely eliminated in practice and display can be performed with high quality.

### Third Modification

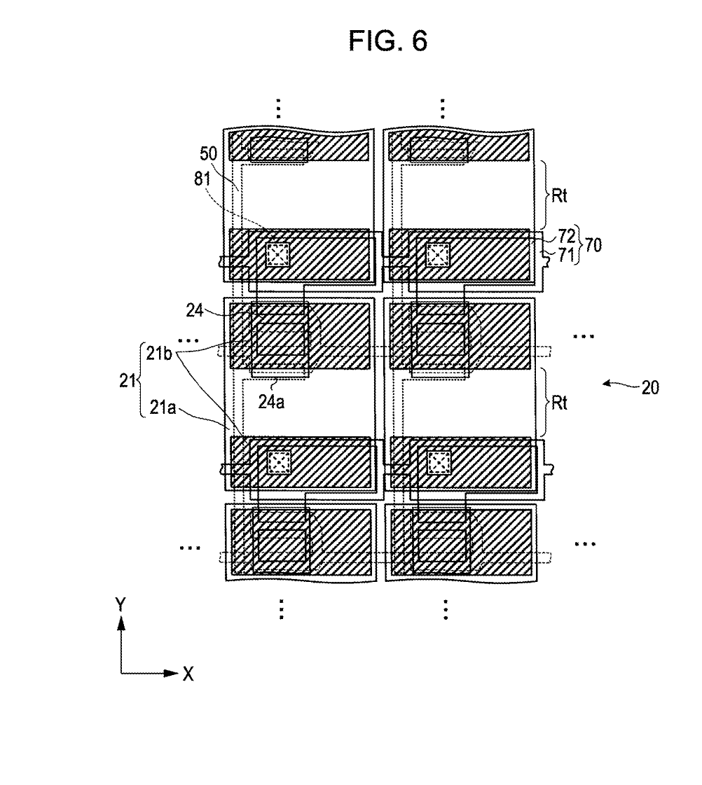

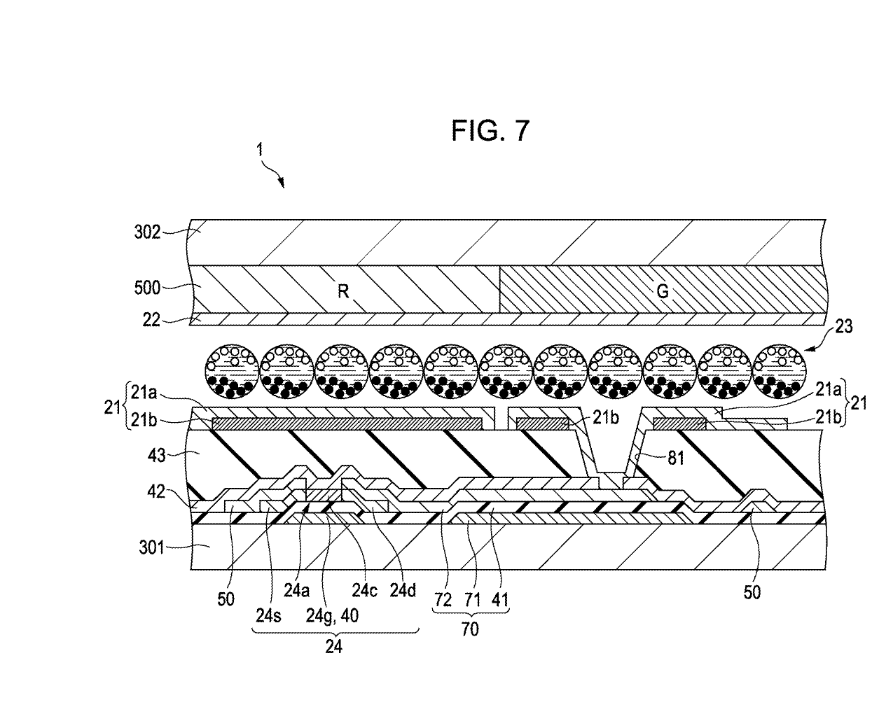

Next, a third modification of the electrophoretic display 1 according to the embodiment will be described with reference to FIGS. 6 and 7. Similarly to FIG. 4, FIG. 6 is a plan view of adjacent pixel units in the third modification of the embodiment and, similarly to FIG. 3, FIG. 7 is a sectional view of adjacent pixel units in the third modification of the embodiment.

As illustrated in FIGS. 6 and 7, in the third modification, the pixel electrode 21 is formed by laminating, in this order from the bottom, a light-shielding electrode layer 21b and a transparent electrode layer 21a. The transparent electrode layer 21a is formed of a material having a property of allowing light to pass therethrough such as ITO and the light-shielding electrode layer 21b is formed of a material having a light-shielding property such as aluminum. The light-shielding electrode layer 21b is arranged so as to cover the pixel-switching transistor 24. Moreover, the light-shielding electrode layer 21b, may be composed of for example an elemental metal, an alloy, a metal silicide, or a polysilicide including at least one light-shielding metal such as titanium (Ti), chromium (Cr), tungsten (W), tantalum (Ta), molybdenum (Mo) or palladium (Pd), besides aluminum, or may be composed of a laminate of any of the above.

Here, the light-shielding electrode layer 21b is arranged so as to be partially covered by the transparent electrode layer 21a when viewed on the substrate 301 in plan view and the pixel electrode 21 is configured such that light can pass through a portion thereof (i.e., a portion of the transparent electrode layer 21a not overlying the light-shielding electrode layer 21b). In other words, the pixel electrode 21 has a transparent region Rt (refer to FIG. 6) through which light can pass, and, out of the transparent electrode layer 21a and the light-shielding electrode layer 21b, only the transparent electrode layer 21a is formed and the light-shielding electrode layer 21b is not formed in the transparent region Rt. Accordingly, reflection of light incident from the outside by the pixel electrode 21 can be suppressed. Therefore, for example, when displaying black, the brightness of black can be suppressed to a low level and contrast can be improved.

That is to say, in the case where the pixel electrode 21 is entirely composed of a material having a light-shielding property such as aluminum, due to light incident from the outside being reflected by the pixel electrode 21, for example, when black is displayed, it becomes difficult to lower the brightness and there is a risk that the contrast will be degraded. However, according to this modification, as described above, since the pixel electrodes 21 are configured so as to allow light to pass through a portion thereof (that is, the transparent region Rt), the contrast can be improved.

This modification is particularly advantageous for example in the case where there are gaps between the microcapsules and the electrophoretic element 23 has a high transmissivity (i.e., the case where outside light readily passes through the electrophoresis element 23). Moreover, an example of the “light-shielding portion” of the first aspect of the invention is a portion of the pixel electrode 21 in which the transparent electrode layer 21a overlies the light-shielding electrode layer 21b when viewed on the substrate in plan view (i.e., a region of the pixel electrode 21 having a light-shielding property) and an example of the “transparent portion” of the first aspect of the invention is a portion of the pixel electrode 21 in which the transparent electrode layer 21a does not overlie the light-shielding electrode layer 21b when viewed on the substrate in plan view (i.e., the transparent region Rt, that is, a region of the pixel electrode 21 having a property of allowing light to pass therethrough). Furthermore, it is preferable that the area of the region of pixel electrode 21 having a light-shielding property be smaller than the area of the region of the pixel electrode 21 having a property of allowing light to pass therethrough. In this case, an advantage of improving the above-described contrast can be obtained with more certainty.

In addition, as illustrated in FIG. 7, in this modification, similarly to in the above-described second modification, a color filter substrate 500 having three coloring layers of red (R), green (G) and blue (B) is provided on the substrate 302 side of the electrophoretic display 1. Furthermore, in FIG. 6, the aspect ratio of the pixel 20 (that is, the ratio of the length of the pixel in the Y direction to the length of the pixel in the X direction) reflects the fact that the color filter substrate 500 has coloring layers of three colors and is 3:1.

### Electronic Appliances

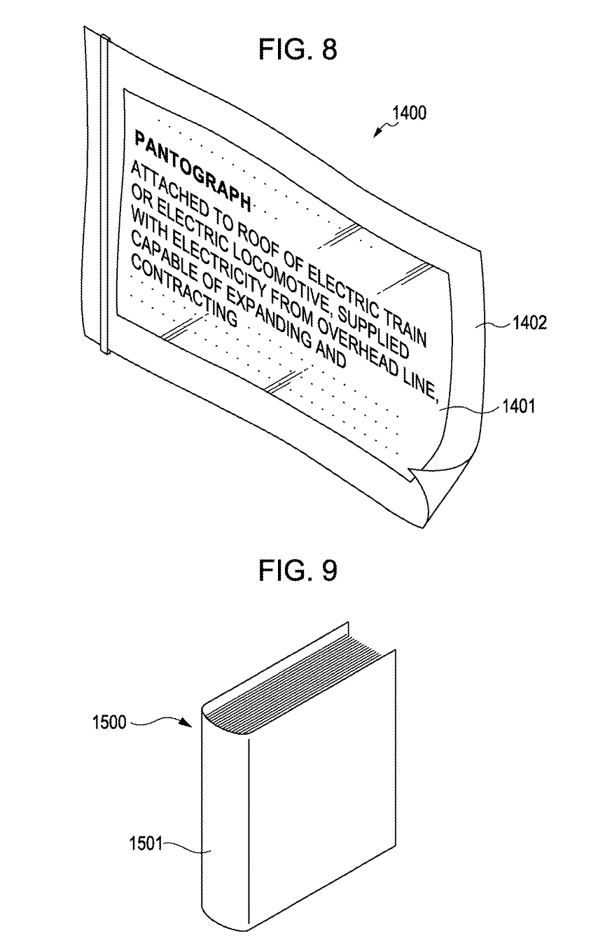

Next, electronic appliances to which the above-described electrophoretic display 1 has been applied will be described with reference to FIGS. 8 and 9. Hereafter, examples in which the electrophoretic display 1 has been applied to an electronic paper sheet and an electronic notebook will be described.

FIG. 8 is a perspective view illustrating the configuration of an electronic paper sheet 1400.

As illustrated in FIG. 8, the electronic paper sheet 1400 includes the electrophoretic display 1 according to the above-described embodiment, which serves as a display unit 1401. The electronic paper sheet 1400 is configured to be flexible and includes a main body 1402 composed of a rewriteable sheet having a texture and pliability similar to those of a conventional paper sheet.

FIG. 9 is a perspective view illustrating the configuration of an electronic notebook 1500.

As illustrated in FIG. 9, the electronic notebook 1500 is formed by bundling together a plurality of electronic paper sheets 1400 illustrated in FIG. 8 and sandwiching the electronic paper sheets 1400 within a cover 1501. The cover 1501 includes a display data input device (not illustrated) for inputting display data sent from for example an external apparatus. With this configuration, displayed content can be modified or updated while keeping the electronic paper sheets in the bundled together state.

The above-described electronic paper sheet 1400 and electronic notebook 1500 each include the electrophoretic display 1 according to the above-described embodiment and therefore high-quality display of an image can be performed and the electronic paper sheet 1400 and the electronic notebook 1500 can share driving control circuits.

Moreover, other than the electronic paper sheet 1400 and the electronic notebook 1500, the electrophoretic display 1 according to the above-described embodiment can be applied to the display units of other electronic appliances such as watches, mobile telephones and mobile audio apparatuses.

Embodiments of the invention are not limited to the above-described embodiment and can be suitably modified within a scope consistent with the gist and ideas of the invention laid out within the claims and the main body of the specification, and an electro-optical-apparatus substrate, an electro-optical apparatus and an electronic appliance realized by making such modifications are also included in the technical scope of the invention.

The entire disclosure of Japanese Patent Application Nos: 2009-052229, filed Mar. 5, 2009 and 2009-213327, filed Sep. 15, 2009 are expressly incorporated by reference herein.

What is claimed is:

1. An electro-optical-apparatus substrate comprising:
a substrate;
a plurality of scanning lines and a plurality of data lines provided on the substrate, the scanning lines and data lines intersecting each other;
a plurality of pixel electrodes provided at intersections of the plurality of scanning lines and the plurality of data lines; and
a plurality of semiconductor devices that control on/off switching of the pixel electrodes, each of the plurality of semiconductor devices corresponding to the pixel electrode;
wherein at least one semiconductor device among the plurality of semiconductor devices is arranged so as to be at least partially covered by another pixel electrode that is adjacent to one pixel electrode that corresponds to the one semiconductor device when viewed on the substrate in plan view.

2. The electro-optical-apparatus substrate according to claim 1, wherein the other pixel electrode is a pixel electrode that is adjacent to the one pixel electrode in the direction in which the data line of the one pixel electrode extends.

3. The electro-optical-apparatus substrate according to claim 1, wherein each of the plurality of pixel electrodes includes a material that exhibits conductivity and has a light-shielding property.

4. The electro-optical-apparatus substrate according to claim 1, wherein each of the plurality of semiconductor devices include a channel region having a channel length that is parallel to the direction in which the data line extends.

5. The electro-optical-apparatus substrate according to claim 1, wherein each of the plurality of pixel electrodes has a transparent portion through which light passes and a light-shielding portion that blocks light, and the light-shielding portion is arranged so as to at least partially cover the one semiconductor device.

6. An electro-optical apparatus comprising:
the electro-optical-apparatus substrate according to claim 1.

7. An electronic appliance comprising:
the electro-optical apparatus according to claim 6.
